(19) United States
(12) Patent Application Publication
(10) Pub. No.: US 2012/0162681 A1
(43) Pub. Date: Jun. 28, 2012

(54) PULL PRINTING SYSTEM AND RECORDING MEDIUM

(75) Inventor: Kouichi TOMITA, Nishiyodogawa-ku (JP)

(73) Assignee: Konica Minolta Business Technologies, Inc., Chiyoda-ku (JP)

(21) Appl. No.: 13/330,732

(22) Filed: Dec. 20, 2011

(30) Foreign Application Priority Data
Dec. 27, 2010 (JP) 2010-290224

(51) Int. Cl. G06K 15/00

(52) U.S. Cl. 358/1.13; 358/1.14

(57) ABSTRACT

A pull printing system includes a print data receiving part, an apparatus model specification part for extracting information on the printing target apparatus model from the print data, an authentication request target determination part for searching for an apparatus of the same model as the printing target apparatus model and determining the apparatus of the same model to be an authentication request target apparatus, an authentication requesting part for transmitting the authentication information, an authentication result receiving part for receiving an authentication result obtained by the authentication operation, and a storage control part for storing the print data into a pull print storage area on the condition that the authentication information is determined to be valid on the basis of the authentication result.

This application is based on Japanese Patent Application No. 2010-290224 filed on Dec. 27, 2010, the contents of which are hereby incorporated by reference.

### BACKGROUND OF THE INVENTION

1. Field of the Invention

The present invention relates to a pull printing system and a technique relevant to the same.

2. Description of the Background Art

Pull printing systems have been used, each of which uses printing apparatuses such as MFPs (Multi-Functional Peripherals). Each of the pull printing systems performs a pull printing operation. Specifically, in a process for such an operation, first, a user gives a print instruction by using a client computer, and then, from the client computer to a server computer (pull print server) or the like, print data is transmitted, to be once stored into the server computer. After that, through a user authentication operation performed by using an operation input part or the like of a printing apparatus (MFP or the like), the printing apparatus acquires (pulls) the print data from the server computer or the like and prints out the print data.

In such a pull printing system, generally, printing software programs such as a printer driver, a port monitor, and the like are installed in each client computer (also referred to simply as a “client”) (see Japanese Patent Application Laid Open Gazette No. 2007-025970). Herein, the “port monitor” has a function of monitoring a “spooler” in the computer, transmitting print data generated by using the printer driver from the spooler to the pull print server or the like, and storing the print data into the pull print server or the like, or like other functions.

In such a technique, a port monitor is installed in each client computer. Therefore, each port monitor directly acquires authentication information (inputted information) inputted by a user and performs an authentication operation by checking the acquired authentication information (inputted information) against a certified authentication information (certified information) stored in the pull print server or the like. Then, only print data which is authenticated is stored into the pull print server.

Herein, installing the software programs such as the printer driver, the port monitor, and the like in each of a plurality of clients needs time and effort.

In order to solve this problem, a technique has been used, in which the printing software programs such as the printer driver, the port monitor, and the like are installed only in a single print server.

In such a case, however, a predetermined printing software program, specifically the “port monitor”, is installed only in the print server but not installed in any client. For this reason, it is not always easy for the port monitor installed in the print server to acquire the authentication information (inputted information) from the client.

In order for the port monitor installed in the print server to acquire the authentication information from the client, considered is, for example, a technique using login information for the OS (Operating System) (“Windows” (registered trademark) or the like) in the client. Specifically, the port monitor in the print server uses the Windows API or the like to acquire the login information (user name) inputted when a user logs in the client, from the client. Then, the acquired user name is used as the authentication information to be checked against the certified authentication information. It is thereby possible to check the validity of the print data. In this technique, the user name included in the login information for the OS is checked without any password information.

It is not necessarily possible in this authentication technique to ensure sufficient security. Especially since only the user name is used for the authentication operation without any password, the third party who knows a user name for login of a user can impersonate the user and transmit the print data (can do so-called “spoofing”).

### SUMMARY OF THE INVENTION

It is an object of the present invention to provide a pull printing system capable of improving security and a technique relevant to the same.

The present invention is intended for a pull printing system. According to a first aspect of the present invention, the pull printing system comprises a plurality of clients, a server and a plurality of printing apparatuses, and in the pull printing system of the first aspect of the present invention, the server comprises a print data receiving part for receiving print data from a print requesting apparatus among the plurality of clients, the print data being generated in response to a user's first operation, in which authentication information which is encrypted, being decryptable by a printing target apparatus model among the plurality of printing apparatuses, is embedded, an apparatus model specification part for extracting information on the printing target apparatus model from the print data to specify the printing target apparatus model, an authentication request target determination part for searching through the plurality of printing apparatuses for an apparatus of the same model as the printing target apparatus model and determining the apparatus of the same model to be an authentication request target apparatus, an authentication requesting part for transmitting the authentication information, being encrypted, to the authentication request target apparatus capable of decrypting the authentication information and requesting the authentication request target apparatus to perform an authentication operation including an operation of decrypting the authentication information, an authentication result receiving part for receiving an authentication result obtained by the authentication operation, and a storage control part for storing the print data into a pull print storage area on the condition that the authentication information is determined to be valid on the basis of the authentication result, and one of the plurality of printing apparatuses which is the printing target apparatus model acquires the print data stored in the pull print storage area and prints out the print data in response to a user's second operation.

According to a second aspect of the present invention, the pull printing system in which a printing apparatus acquires print data stored in a pull print storage area and prints out the print data in response to an operation of a print requesting apparatus relating to printing, comprises a print data receiving part for receiving print data in which authentication information which is encrypted, being decryptable by a printing target apparatus model, is embedded, from a print requesting apparatus, an apparatus model specification part for extracting information on the printing target apparatus model from the print data to specify the printing target apparatus model, an authentication request target determination part for searching for an apparatus of the same model as the printing target apparatus model and determining the apparatus of the same model to be an authentication request target apparatus, an authentication requesting part for transmitting the authentication information, being encrypted, to the authentication request target apparatus capable of decrypting the authentication information and requesting the authentication request target apparatus to perform an authentication operation including an operation of decrypting the authentication information, an authentication result receiving part for receiving an authentication result obtained by the authentication operation, and a storage control part for storing the print data into a pull print storage area on the condition that the authentication information is determined to be valid on the basis of the authentication result.

The present invention is also intended for a non-transitory computer-readable recording medium. According to a third aspect of the present invention, the non-transitory computer-readable recording medium records therein a computer program to be executed by a computer to cause the computer to perform the steps of a) receiving print data in which authentication information which is encrypted, being decryptable by a printing target apparatus model, is embedded, from a print requesting apparatus, b) extracting information on the printing target apparatus model from the print data to specify the printing target apparatus model, c) searching for an apparatus of the same model as the printing target apparatus model and determining the apparatus of the same model to be an authentication request target apparatus, d) transmitting the authentication information, being encrypted, to the authentication request target apparatus capable of decrypting the authentication information and requesting the authentication request target apparatus to perform an authentication operation including an operation of decrypting the authentication information, e) receiving an authentication result obtained by the authentication operation, and f) storing the print data into a pull print storage area on the condition that the authentication information is determined to be valid on the basis of the authentication result.

According to a fourth aspect of the present invention, the pull printing system comprises a plurality of clients, a server, and a plurality of printing apparatuses, and in the pull printing system of the fourth aspect of the present invention, the server comprises a print data acquisition part for acquiring print data generated and stored into a pull print storage area in response to a user's first operation from the pull print storage area in response to a user's second operation, the print data having authentication information which is encrypted and embedded therein, said authentication information being decryptable by a printing target apparatus model among the plurality of printing apparatuses, an apparatus model specification part for extracting information on the printing target apparatus model from the print data to specify the printing target apparatus model, an authentication request target determination part for searching through the plurality of printing apparatuses for an apparatus of the same model as the printing target apparatus model and determining the apparatus of the same model to be an authentication request target apparatus, an authentication requesting part for transmitting the authentication information, being encrypted, to the authentication request target apparatus capable of decrypting the authentication information and requesting the authentication request target apparatus to perform an authentication operation including an operation of decrypting the authentication information, an authentication result receiving part for receiving an authentication result obtained by the authentication operation, and a print control part for permitting one of the plurality of printing apparatuses which is the printing target apparatus model to print out the print data on the condition that the authentication information is determined to be valid on the basis of the authentication result, and the one printing apparatus acquires the print data stored in the pull print storage area and prints out the print data.

According to a fifth aspect of the present invention, the pull printing system in which a printing apparatus acquires print data stored in a pull print storage area and prints out the print data in response to an operation of a print requesting apparatus relating to printing, comprises a print data acquisition part for acquiring print data in which authentication information which is encrypted, being decryptable by a printing target apparatus model, is embedded, from the pull print storage area, an apparatus model specification part for extracting information on the printing target apparatus model from the print data to specify the printing target apparatus model, an authentication request target determination part for searching for an apparatus of the same model as the printing target apparatus model and determining the apparatus of the same model to be an authentication request target apparatus, an authentication requesting part for transmitting the authentication information, being encrypted, to the authentication request target apparatus capable of decrypting the authentication information and requesting the authentication request target apparatus to perform an authentication operation including an operation of decrypting the authentication information, an authentication result receiving part for receiving an authentication result obtained by the authentication operation, and a print control part for permitting printing of the print data on the condition that the authentication information is determined to be valid on the basis of the authentication result.

According to a sixth aspect of the present invention, the non-transitory computer-readable recording medium records therein a computer program to be executed by a computer to cause the computer to perform the steps of a) acquiring print data in which authentication information which is encrypted, being decryptable by a printing target apparatus model, is embedded, from a pull print storage area, b) extracting information on the printing target apparatus model from the print data to specify the printing target apparatus model, c) searching for an apparatus of the same model as the printing target apparatus model and determining the apparatus of the same model to be an authentication request target apparatus, d) transmitting the authentication information, being encrypted, to the authentication request target apparatus capable of decrypting the authentication information and requesting the authentication request target apparatus to perform an authentication operation including an operation of decrypting the authentication information, e) receiving an authentication result obtained by the authentication operation, and f) permitting printing of the print data on the condition that the authentication information is determined to be valid on the basis of the authentication result.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a conceptual diagram showing an overview of a pull printing system in accordance with a first preferred embodiment;

FIG. 2 is a functional block diagram showing a schematic constitution of an MFP;

FIG. 3 is a functional block diagram showing a schematic constitution of a computer;

FIG. 4 is a functional block diagram showing a schematic constitution of a print server;

FIG. 5 is a view showing programs and the like installed in apparatuses;

FIG. 6 is a flowchart showing an operation of a port monitor, and the like;

FIG. 7 is a view showing transmission and reception of print data and authentication information, and the like;

FIG. 8 is a view showing a setting screen relating to a printer;

FIG. 9 is a view showing an input screen for user authentication information;

FIG. 10 is a view showing print data;

FIG. 11 is a view showing a manner where the print data is transmitted to the print server;

FIG. 12 is a view showing an operation of sending an authentication request instruction;

FIG. 13 is a view showing an operation of transmitting an authentication result;

FIG. 14 is a view showing a manner where the print data is transmitted to a pull print server;

FIG. 15 is a view showing a manner where the print data is transmitted to the MFP and a printing operation is performed;

FIG. 16 is a functional block diagram showing a schematic constitution of a pull print server in accordance with a second preferred embodiment;

FIG. 17 is a view showing programs and the like installed in apparatuses;

FIG. 18 is a view showing transmission and reception of the print data and the authentication information, and the like;

FIG. 19 is a flowchart showing an operation of the port monitor, and the like;

FIG. 20 is a view showing a manner where the print data is transmitted to the print server;

FIG. 21 is a view showing a manner where the print data is transmitted to the pull print server;

FIG. 22 is a view showing a manner where a print request is sent to the pull print server;

FIG. 23 is a view showing an operation of sending the authentication request instruction;

FIG. 24 is a view showing an operation of transmitting the authentication result; and

FIG. 25 is a view showing an operation of sending a print permission.

### DESCRIPTION OF THE PREFERRED EMBODIMENTS

Hereinafter, the preferred embodiments of the present invention will be discussed with reference to the accompanying drawings.

### 1. The First Preferred Embodiment

<1-1. Overview of System>

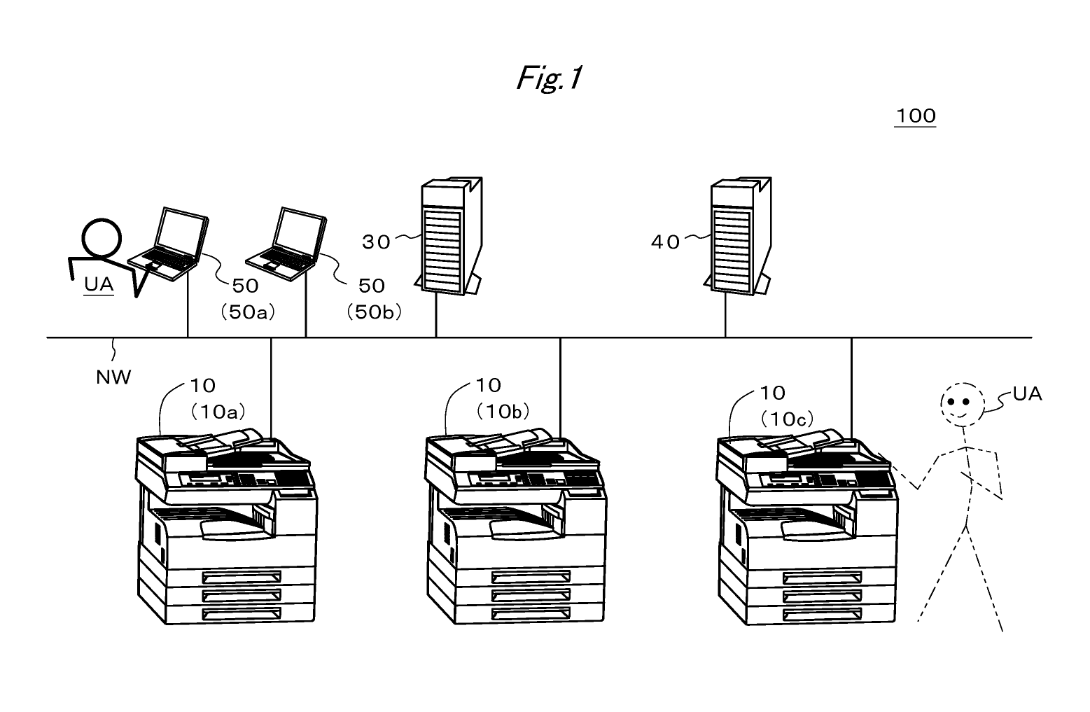

FIG. 1 is a conceptual diagram showing an overview of a pull printing system 100 (also referred to as 100A) in accordance with the first preferred embodiment.

As shown in FIG. 1, the pull printing system 100A comprises a plurality of printers 10 (in more detail, 10a, 10b, 10c, . . . ) and a plurality of client computers 50 (50a, 50b, . . . ). Herein, as an example of a printer 10, shown is an MFP (Multi-Functional Peripheral). Further, the MFP 10a and the MFP 10b are different apparatus models and the MFP 10b and the MFP 10c are the same apparatus model.

The pull printing system 100A is a system in which a printing apparatus (e.g., the MFP 10c) acquires (pulls) and prints out print data stored in a pull print storage area SR (described later) in response to an operation of a print requesting apparatus (e.g., a client computer 50a) relating to printing.

Each of the MFPs 10 is connected to each of the client computers (hereinafter, also referred to simply as “clients”) 50 via a network NW and network communication can be achieved between the MFP 10 and the client 50. The network NW includes various networks such as a LAN (Local Area Network), a WAN (Wide Area Network), the internet, and the like. The connection to the network NW may be wired or wireless.

The pull printing system 100A further comprises a computer 30 and a computer 40. The computer 30 is a server computer having a print server function and the computer 40 is a server computer having a pull print server function. The computer 30 is also referred to simply as a “print server” and the computer 40 is also referred to simply as a “pull print server”.

In the pull printing system 100, the above-discussed pull printing operation is performed as well as a normal printing operation.

Printer drivers PD (PDa, PDb, . . . ) of the MFPs 10 (10a, 10b, 10c, . . . ) are installed only in the print server 30 as a general rule and the print server 30 intensively manages the printer drivers PD. This allows very efficient systems operation. Specifically, the printer drivers PD of all the MFPs 10 are installed only in the print server 30, not in any one of the clients 50 as a general rule. Each of the clients 50 uses a clone (duplicate) of the printer driver PD installed in the print server 30. Since the MFP 10b and the MFP 10c are the same apparatus model as discussed above, the same printer driver PDb for the MFP 10b and the MFP 10c is installed in the print server 30.

Further, in the first preferred embodiment, a port monitor program (hereinafter, also referred to simply as a “port monitor”) PM which is a pull printing software program is installed only in the print server 30, not in any one of the clients 50. In other words, the print server 30 intensively manages the port monitor PM. This allows very efficient systems operation. The “port monitor” has a function of monitoring a “spooler” in the computer, transmitting print data generated by using the printer driver from the spooler to the pull print server or the like, and storing the print data into the pull print server or the like, or like other functions.

In the pull printing system 100A, print data DT are transmitted from a plurality of clients 50 to the print server 30 and once stored into a pull print storage area SR inside the pull print server 40. After that, a user uses an operation panel or the like of the MFP 10 to give the MFP 10 a print instruction for actually printing out the print data DT which is transmitted to the print server 30 in advance. In response to the print instruction, the MFP 10 acquires the print data DT specified by the print instruction from the pull print storage area SR of the pull print server 40 and performs a printing operation on the basis of the print data DT.

In this case, however, the port monitor PM is installed only in the print server 30 but not installed in any client. For this reason, it is not always easy for the port monitor PM installed in the print server 30 to acquire authentication information (inputted information) from the client 50.

In order for the port monitor installed in the print server to acquire the authentication information from the client, considered is a technique in accordance with the following first comparative example.

The technique in accordance with the first comparative example is a technique using login information for the OS (e.g., Windows (registered trademark)) in the client. Specifically, the port monitor in the print server uses the Windows API or the like to acquire the login information (user name) inputted when a user logs in the client, from the client. Then, the acquired user name is used as the authentication information to be checked against the certified authentication information. It is thereby possible to check the validity of the print data. In this technique, the user name included in the login information for the OS is checked without any password information.

In such authentication, however, since the login information for the OS is used in place of the authentication information for pull printing, it is not necessarily possible to ensure sufficient security. Especially since only the user name is used for the authentication operation without any password, the third party who knows a user name for login of a user can impersonate the user and transmit the print data (can do so-called “spoofing”). In more detail, even when the third party transmits the print data by using only the “user name” included in the login information of a person for the OS, i.e., by “spoofing”, it is hard to correctly determine whether the print data is transmitted by “spoofing” or not. Therefore, there is a possibility that the third party intentionally transmits a large amount of print data to bring the pull print storage area of the pull print server into a saturated state and the system thereby goes down. There is another possibility that a user who does not know that the print data is invalid prints out unnecessary printed matters.

Then, in the first preferred embodiment, proposed is a technique that allows the port monitor PM on the print server 30 to acquire authentication information AT by using the print data DT.

The authentication information AT embedded in the print data DT which is generated by using the printer driver PDb is, however, encoded (encrypted) for the purpose of ensuring security. Specifically, the authentication information AT is encrypted, being decodable (decryptable) with a decoding (decrypting) key unique to the apparatus model. In other words, the authentication information AT is encrypted, being decryptable by printing target apparatus models (herein, the MFPs 10c and 10b).

Since the port monitor PM on the print server 30 does not have any decrypting key unique to the apparatus model, however, it is not easy for the port monitor PM to acquire the authentication information AT.

In order to solve such a problem, in the first preferred embodiment, the port monitor PM transmits the encrypted authentication information AT to the apparatus 10b of the same model as a printing target apparatus model (e.g., “ABCDE”) associated with the printer driver PD. The MFP 10b is the same apparatus model as the printing target apparatus model and has a decrypting key unique to the apparatus model. Therefore, the MFP 10b can decode (decrypt) the encrypted authentication information AT which is embedded in the printer driver PD. Then, the destination apparatus performs an authentication operation. Thus, the port monitor PM on the print server 30 acquires the authentication information AT via the printer driver PD and the authentication operation using the authentication information AT is performed.

Hereinafter, such a system will be described in more detail.

<1-2. Constitution of MFP>

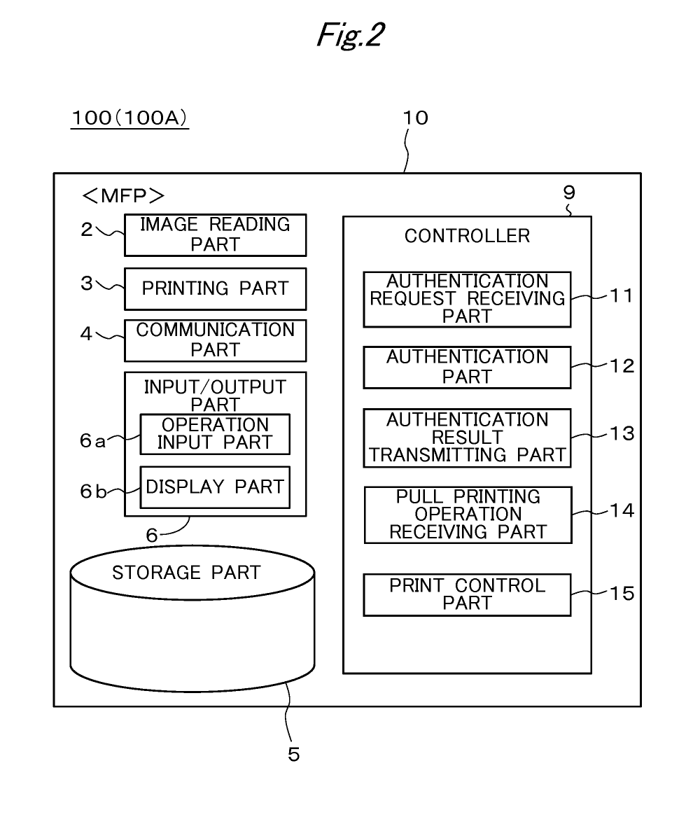

FIG. 2 is a functional block diagram showing a schematic constitution of the MFP 10.

As shown in the functional block diagram of FIG. 2, the MFP 10 comprises an image reading part 2, a printing part 3, a communication part 4, a storage part 5, an input/output part 6, a controller 9, and the like and multiply uses these constituent parts to implement various functions. The MFP 10 is also expressed as an image forming apparatus or a printing apparatus.

The image reading part 2 is a processing part which optically reads (in other words, scans) an original manuscript placed on a predetermined position of the MFP 10 and generates image data of the original manuscript (referred to also as an “original manuscript image” or a “scan image”). The image reading part 2 is also referred to as a scanning part.

The printing part 3 is an output part which prints out an image to various media such as paper on the basis of the data on an object to be printed.

The communication part 4 is a processing part capable of performing facsimile communication via public networks or the like. Further, the communication part 4 is capable of performing network communication via a network NW. The network communication uses various protocols such as TCP/IP (Transmission Control Protocol/Internet Protocol), FTP (File Transfer Protocol), and the like, and by using the network communication, the MFP 10 can transmit and receive various data to/from desired partners. Further, the MFP 10 can transmit and receive E-mails by using the communication part 4.

The storage part 5 is a storage unit such as a hard disk drive (HDD) or/and the like. The storage part 5 has one or a plurality of boxes. Each of the boxes corresponds to a storage area provided in the MFP 10. In the box, stored are various data files and the like.

The input/output part 6 comprises an operation input part 6a for receiving an input which is given to the MFP 10 and a display part 6b for displaying various information thereon. In more detail, the MFP 10 is provided with an operation panel 6c (not shown). The operation panel (touch screen) 6c is a liquid crystal display panel in which a piezoelectric sensor or the like is embedded, serving as part of the display part 6b and also serving as part of the operation input part 6a.

The controller 9 is a control unit for generally controlling the MFP 10. The controller 9 is a computer system which is embedded in the MFP 10 and comprises a CPU and various semiconductor memories (RAM, ROM, and the like). The controller 9 causes the CPU to execute a predetermined software program (hereinafter, referred to simply as a “program”) PG1 stored in the ROM (e.g., EEPROM or the like), to thereby implement various processing parts. Further, the program PG1 may be acquired via various portable (in other words, non-transitory) computer-readable recording media (a USB memory or the like). Alternatively, the program PG may be downloaded via the network or the like and installed into the MFP 10.

As shown in FIG. 2, the controller 9 implements various processing parts including an authentication request receiving part 11, an authentication part 12, an authentication result transmitting part 13, a pull printing operation receiving part 14, and a print control part 15.

The authentication request receiving part 11 is a processing part for receiving an authentication request from the print server 30.

The authentication part 12 is a processing part for performing an operation of authenticating the authentication information AT, in more detail, an authentication operation together with an operation of decrypting the authentication information AT.

The authentication result transmitting part 13 is a processing part for transmitting a authentication result obtained by the authentication operation of the authentication part 12 to the print server 30.

The pull printing operation receiving part 14 is a processing part for receiving an instruction for performing printing (pull printing) of the print data DT stored in the pull print server 40.

The print control part 15 is a processing part for controlling a printing operation of the printing part 3.

<1-3. Constitution of Print Server>

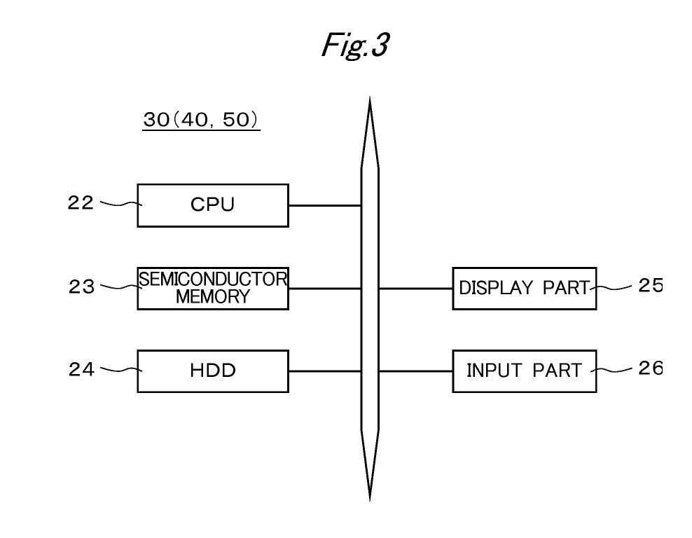

The print server 30 is a computer system (computer). Specifically, as shown in FIG. 3, the print server 30 comprises a CPU 22, a semiconductor memory (RAM or the like) 23, a hard disk drive (HDD) 24, a display part (liquid crystal display part or the like) 25, an input part (a keyboard, a mouse, and the like) 26 (see FIG. 3). The print server 30 uses the CPU 22 and the like to execute various programs (such as the printer driver PD, the port monitor PM, and the like), to thereby implement various functions. The various programs (the printer driver PD, the port monitor PM, and the like) are recorded in various portable (in other words, non-transitory) computer-readable recording media such as a CD-ROM, a DVD-ROM, a USB memory, and the like and installed in the print server 30 via the recording medium. Alternatively, the various programs (the printer driver PD, the port monitor PM, and the like) may be installed into the print server 30 via the network or the like.

The print server 30, in which a predetermined OS (Operating System) is installed, can execute a plurality of software programs on the OS. These plurality of software programs include the above-discussed printer driver PD and the port monitor PM.

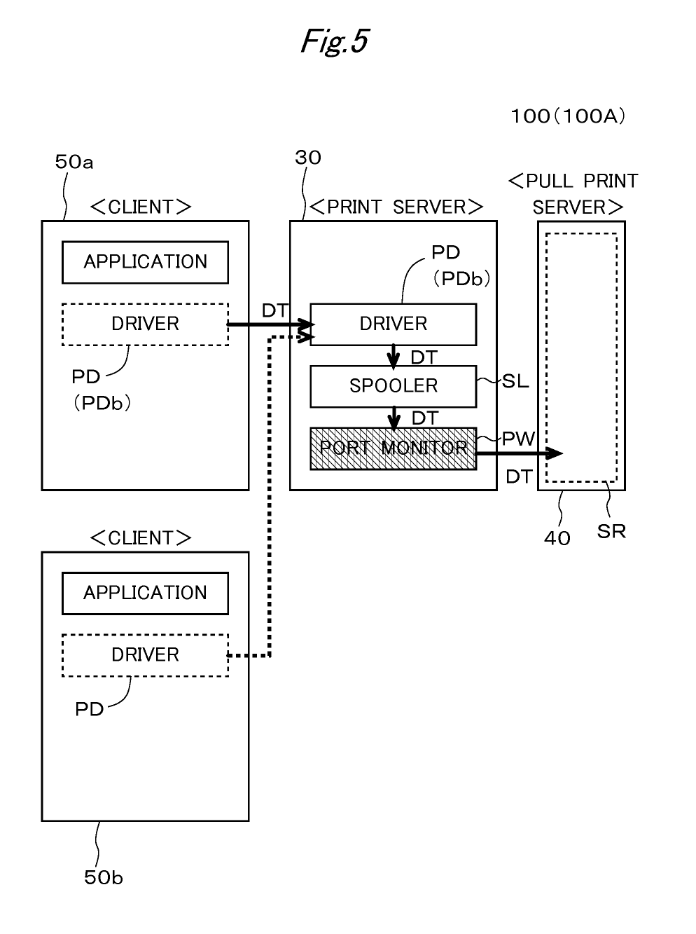

As discussed above, the printer drivers PD of all the MFPs 10 are installed in the print server 30 (see FIG. 5). Especially, the printer drivers PD of all the MFPs 10 are installed only in the print server 30, not in any one of the clients 50. In other words, the print server 30 intensively manages the printer drivers PD. This allows very efficient systems operation. Further, each of the clients 50 uses a clone (duplicate) or the like of the printer driver PD installed in the print server 30.

The port monitor program (hereinafter, referred to simply as the “port monitor”) PM which is a pull printing software program is installed in the print server 30 (see FIG. 5). Especially, the port monitor PM is installed only in the print server 30, not in any one of the clients 50. In other words, the print server 30 intensively manages the port monitor PM. This allows very efficient systems operation.

As discussed later, the print data DT which is generated by using the printer driver PD is temporarily stored into the spooler SL of the print server 30. Then, the port monitor PM sequentially acquires the print data DT stored in the spooler SL and performs after-mentioned operations to store the print data DT which is confirmed to be valid (in other words, authenticated) into the pull print storage area SR of the pull print server 40.

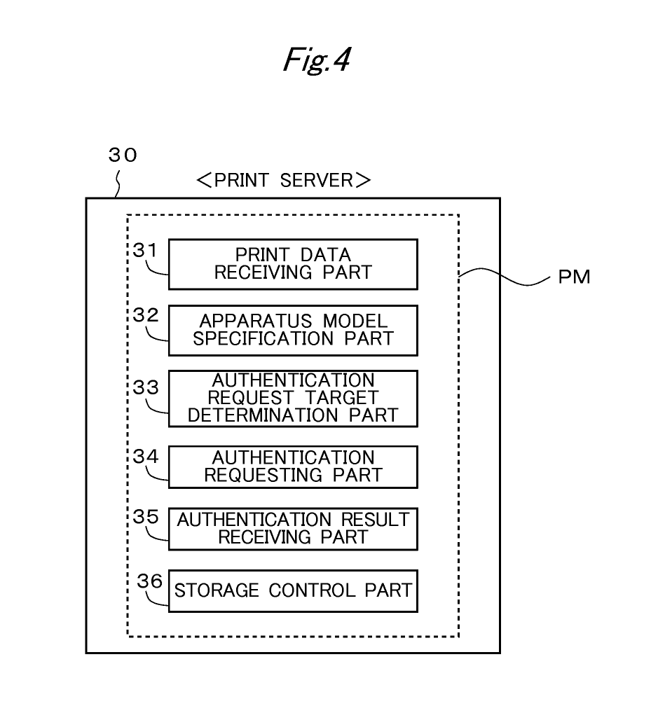

The print server 30 comprises a print data receiving part 31, an apparatus model specification part 32, an authentication request target determination part 33, an authentication requesting part 34, an authentication result receiving part 35, and a storage control part 36, as shown in FIG. 4. These processing parts are implemented as functioning parts of the port monitor PM. FIG. 4 is a functional block diagram showing a constitution of the print server 30.

The print data receiving part 31 is a processing part for receiving the print data DT in which the encrypted authentication information (specifically, pieces of information on a user ID, a password, and the like) AT is embedded from a “print requesting apparatus” (e.g., the client 50a) among the plurality of clients 50 via the spooler SL or the like. The authentication information AT is encrypted, being decryptable by a printing target apparatus model (e.g., the MFPs 10b and 10c) among the plurality of MFPs 10 (printing apparatuses). The print data receiving part 31 is also referred to as a print data acquisition part.

The apparatus model specification part 32 is a processing part for extracting and acquiring information on the “printing target apparatus model” for the print data DT from the print data DT, to thereby specify the printing target apparatus model.

The authentication request target determination part 33 is a processing part for searching through management object apparatuses (herein, a plurality of MFPs 10) in the pull printing system 100A for an apparatus of the same model as the printing target apparatus model and determining the apparatus of the same model to be an “authentication request target apparatus”.

The authentication requesting part 34 is a processing part for transmitting the encrypted authentication information AT to the authentication request target apparatus and requesting the authentication request target apparatus to perform the authentication operation including the operation of decrypting the authentication information AT. The authentication requesting part 34 transmits the encrypted authentication information AT to the authentication request target apparatus which is capable of decrypting the authentication information AT.

The authentication result receiving part 35 is a processing part for receiving the authentication result RT obtained by the authentication operation.

The storage control part 36 is a processing part for controlling whether the print data DT should be stored into the pull print storage area SR or not. The storage control part 36 stores the print data DT into the pull print storage area SR on the condition that the authentication information AT is determined to be valid (in other words, authenticated) on the basis of the authentication result RT.

<1-4. Constitution of Pull Print Server>

The pull print server 40 is also a computer system (computer) like the print server 30.

The pull print server 40 has a storage area SR for storing pull print data therein (see FIG. 5). The print data DT stored in the storage area SR is transmitted from the storage area SR of the pull print server 40 to the MFP 10 in response to an operation input (input of authentication information or the like) through the operation panel 6c or the like of the MFP 10. A printing operation (pull printing operation) based on the print data DT is thereby performed in the MFP 10.

<1-5. Constitution of Client Computer>

The client computer 50 is also a computer system (computer) like the print server 30.

The client 50, in which a predetermined OS (Operating System) is installed, can execute a plurality of software programs on the OS. These plurality of software programs include a relatively higher-level application software (e.g., word processor) and the like.

As discussed above, in each of the clients 50, a clone (duplicate) of the printer driver PD installed in the print server 30 is generated and used. Specifically, as discussed later, part of the printer driver PD which relates to acquisition of the authentication information (an input function for the user authentication information) or the like is used. In other words, no inherent printer driver PD is installed but the clone (duplicate) of the printer driver PD is used in each of the clients 50. In FIG. 5, the printer driver PD in the client 50 is surrounded by a broken line while the printer driver PD in the print server 30 is surrounded by a solid line. This indicates that the printer driver PD in the client 50 is not one that is installed inherently in the client 50 but is a clone which is generated by duplicating the printer driver PD in the print server 30.

Though the case where a clone of the printer driver PD is generated in each of the clients 50 has been discussed in the first preferred embodiment, the present invention is not limited to a case where a complete clone is generated in the client 50. There may be a case, for example, where only some of the functions in the printer driver PD are duplicated in the client 50 and the some functions (the input function for the user authentication information and the like) are implemented in the client 50.

Further, as discussed above, the port monitor PM is not installed in any one of the clients 50.

<1-6. Operation of System>

Next, an operation of the pull printing system 100A will be discussed.

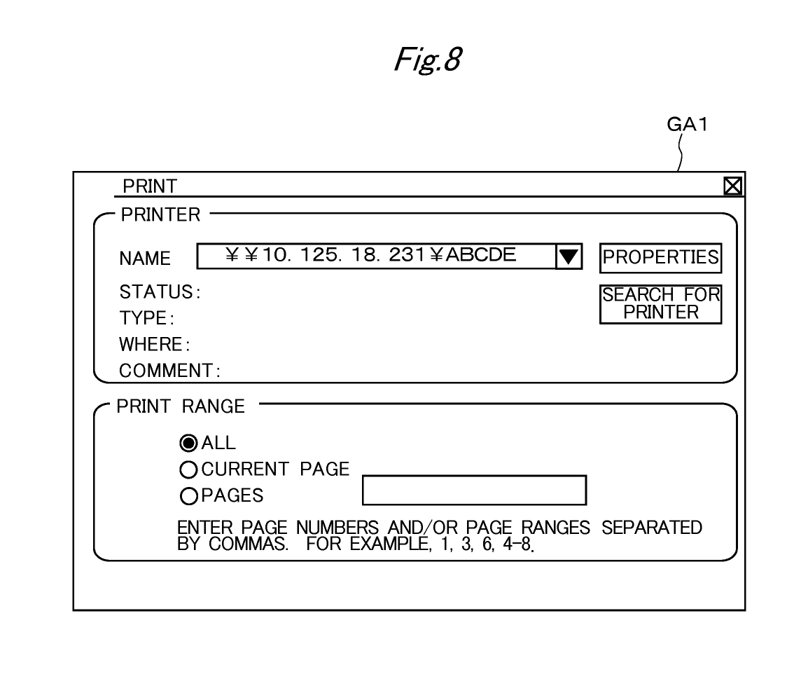

When a user UA selects a “printing” command in the application program (word processor or the like) being executed in the client 50, a setting screen GA1 relating to a printer (see FIG. 8) is displayed on a display part of the client 50. Herein, in the setting screen GA1, the user UA selects a shared printer “¥¥10.125.18.231¥ABCDE” as the printing target apparatus (output target printer). “¥¥10.125.18.231” indicates an IP address of the print server 30. By specifying the IP address of the print server 30 as an output destination port, the print data DT is transmitted to the print server 30.

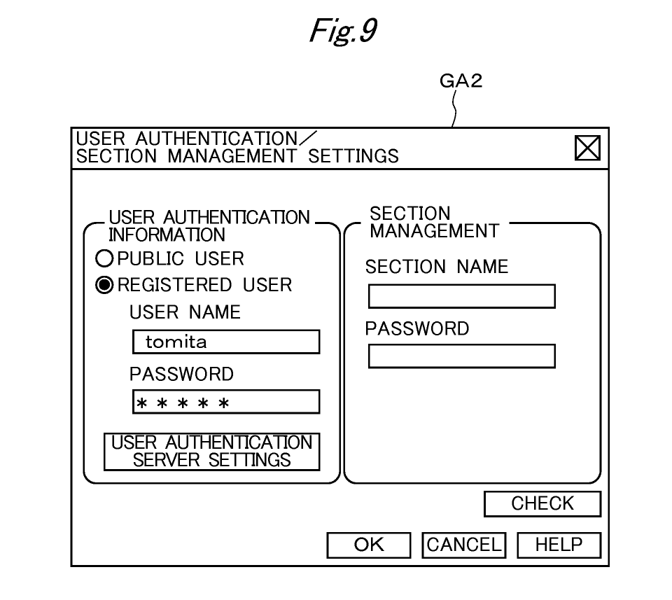

When the user UA operates the setting screen GA1 to display a property setting screen (not shown) of the shared printer and presses an authentication information input button (not shown) in the property setting screen, an input screen GA2 for the user authentication information AT is displayed on the display part of the client 50 as shown in FIG. 9.

The user UA uses the input screen GA2 for the user authentication information AT to input the authentication information AT for the MFP 10. Specifically, the user UA inputs a user ID (user name) and a password.

The printer driver PD generates the print data DT on the basis of the authentication information AT. The print data DT is data written by a predetermined page description language (PDL) or the like.

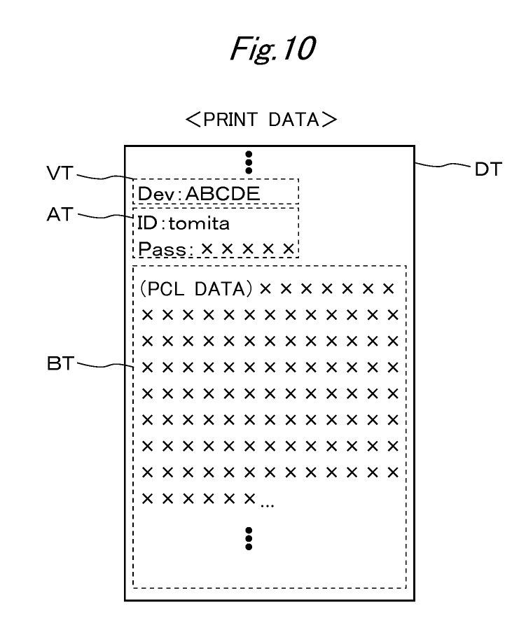

FIG. 10 is a view showing an example of print data DT. As shown in FIG. 10, in the print data DT, written are printing target apparatus model information (apparatus model name or the like) VT, the authentication information AT, and the like, as well as print content data (original data body to be printed out) BT. In this case, “ABCDE” is written as the apparatus model information VT, and a user ID “tomita” and a password “123456” are written as the authentication information AT.

The apparatus model information VT, not being encrypted, is embedded in the print data DT. On the other hand, the authentication information AT, being encrypted, is embedded in the print data DT. This ensures the security. Decrypting of the authentication information AT in the print data DT can be achieved only by using a decrypting key unique to an apparatus model “ABCDE” associated with the encrypting driver PD (a printing target apparatus model associated with the printer driver PD which performs the encrypting operation). The print content data (original data body to be printed out) BT does not necessarily need to be encrypted, but in terms of security, it is preferable that the print content data BT should be also encrypted.

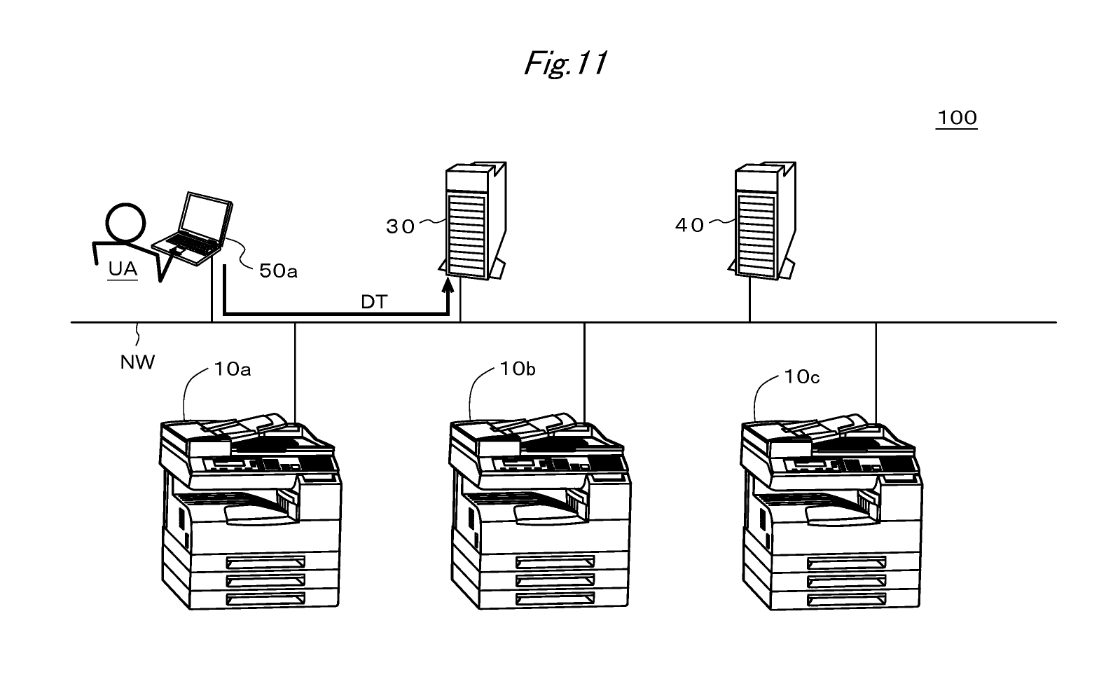

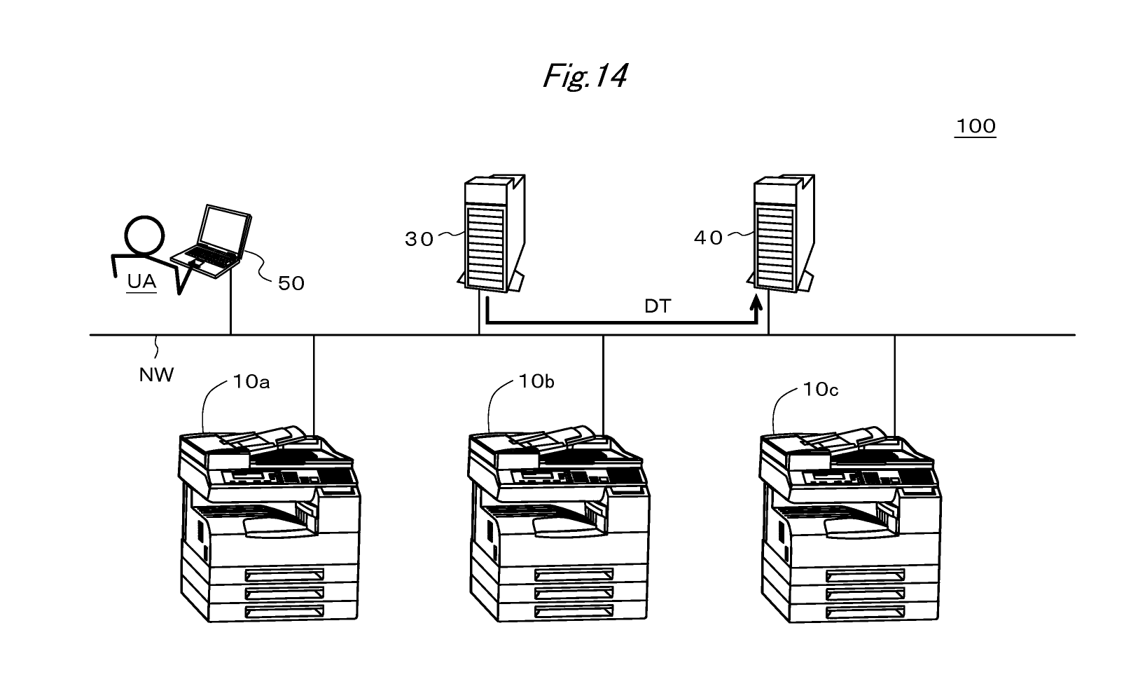

The print data DT which is generated thus by using the printer driver PD (PDb) in response to the operation of the user UA is transmitted to the print server 30 (see FIGS. 5, 7, 11, and the like). In more detail, the print data DT is temporarily stored into the spooler SL of the print server 30 (see especially FIG. 5). FIGS. 11 to 15 are views sequentially showing the transmission of the data and the like in the present system 100A.

Next, when the port monitor PM which monitors the spooler SL detects the print data DT in the spooler SL, the port monitor PM receives and acquires the print data DT. In other words, the port monitor PM (in more detail, the print data receiving part 31) receives the print data DT in which the encrypted authentication information AT is embedded from the client 50a (print requesting apparatus) (see especially FIG. 5).

Thus, the authentication information AT inputted by the user UA using the user interface of the printer driver is encrypted and embedded into the print data DT and then given over to the port monitor PM.

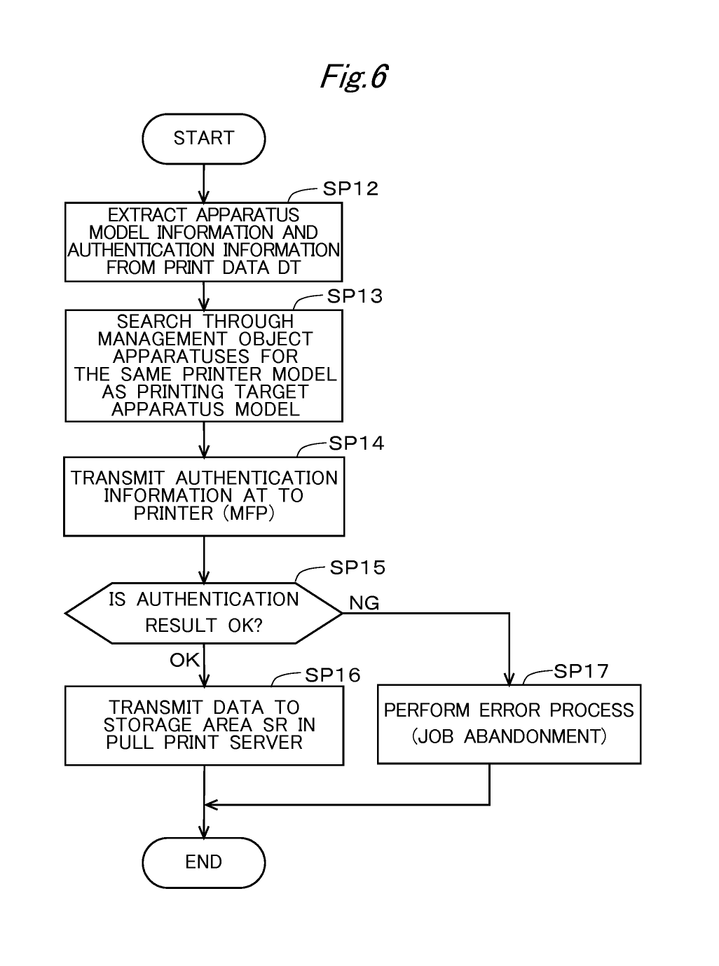

When the print data DT is print data for pull printing, an operation shown in the flowchart of FIG. 6 is performed.

First, in Step SP12, the port monitor PM (in more detail, the apparatus model specification part 32) extracts and acquires the apparatus model information VT (see FIG. 10) from the print data DT, to thereby specify the printing target apparatus model. For example, when the apparatus model “ABCDE” is acquired as the apparatus model information VT, the port monitor PM specifies the apparatus model “ABCDE” as the printing target apparatus model. The port monitor PM further extracts and acquires the authentication information AT. At that time, the authentication information AT, being encrypted, is extracted and acquired.

In Step SP13, the port monitor PM (in more detail, the authentication request target determination part 33) searches for an apparatus of the same model as the printing target apparatus model and determines the apparatus of the same model to be the authentication request target apparatus.

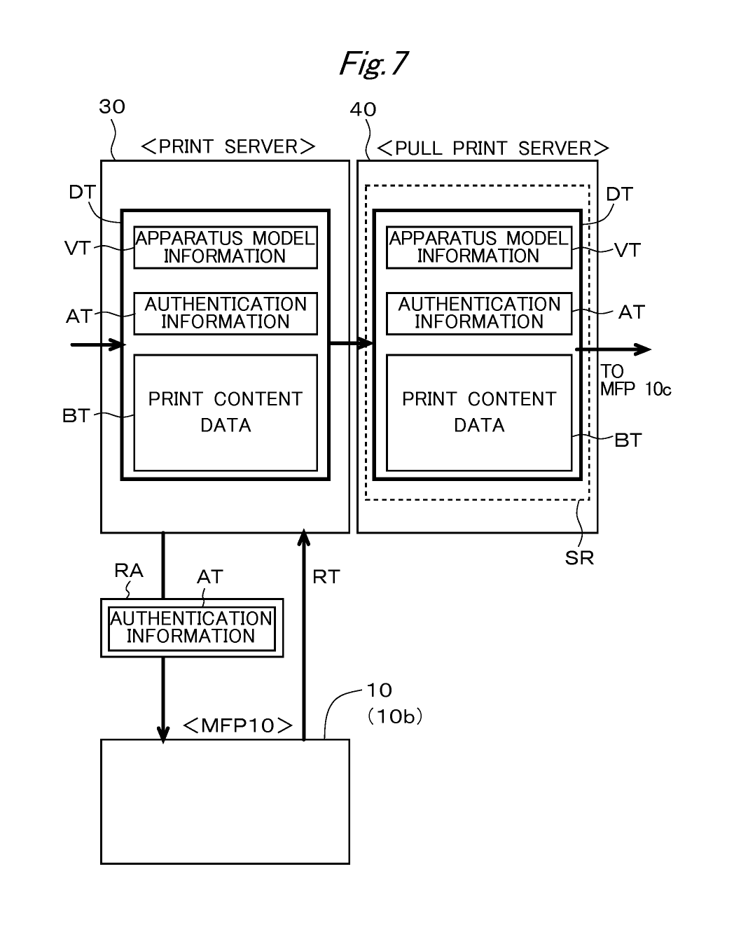

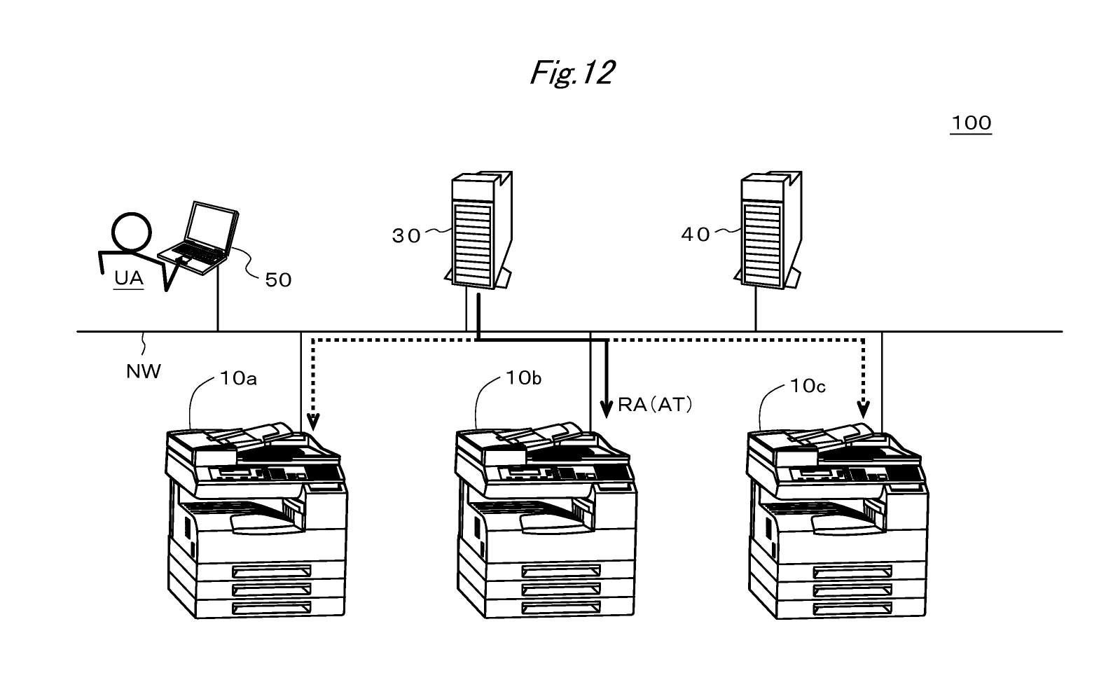

Next, in Step SP14, the port monitor PM (in more detail, the authentication requesting part 34) transmits the encrypted authentication information AT to the “authentication request target apparatus” and requests the “authentication request target apparatus” (e.g., the MFP 10b) to perform an authentication operation on the authentication information AT (see FIGS. 7 and 12).

Specifically, the port monitor PM sends an authentication request instruction RA to the authentication request target apparatus 10b. The authentication request instruction RA is instruction data requesting the authentication information on the authentication information AT together with an operation of decrypting the authentication information AT, which has the encrypted authentication information AT. Herein, the authentication request instruction RA has only authentication information AT out of the print data DT. This reduces the communication load.

Thus, the port monitor PM extracts the encrypted authentication information AT from the print data DT and requests the same apparatus model (associated with the printer driver) which is capable of decrypting the authentication information AT to perform the authentication operation.

On the other hand, the “authentication request target apparatus” (e.g., the MFP 10b) which receives the authentication request instruction RA (including the encrypted authentication information AT) uses the authentication part 12 to perform the authentication operation. In other words, when the “authentication request target apparatus” receives the “authentication request” from the “authentication requesting apparatus” (e.g., the print server 30) by using the authentication request receiving part 11, the “authentication request target apparatus” performs the authentication operation. The “authentication request target apparatus” (e.g., the MFP 10b) is an apparatus model associated with the encrypting driver (an apparatus model associated with the printer driver PD which performs the encrypting operation) and an apparatus which is capable of decrypting the encrypted authentication information AT.

The authentication request target apparatus (e.g., the MFP 10b) decrypts the encrypted authentication information AT embedded in the print data DT and checks the decrypted authentication information AT against the certified authentication information (certified information) CT stored in the MFP 10.

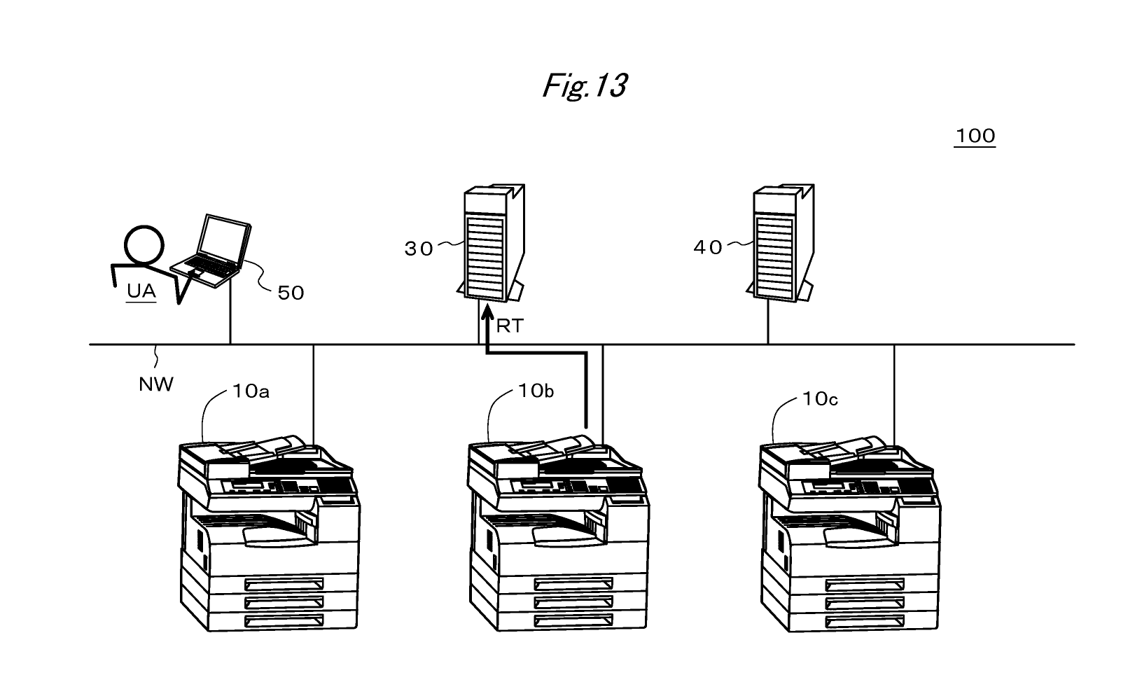

Then, as shown in FIG. 13, the check result (i.e., the authentication result) RT is transmitted (sent back) to the print server 30 by the authentication result transmitting part 13 (see FIG. 2) (also see FIG. 7).

When the port monitor PM in the print server 30 receives the authentication result by using the authentication result receiving part 35, the port monitor PM performs a branch operation in accordance with the authentication result (Step SP15).

When the authentication information AT is not determined to be valid, the process goes to Step SP17 where an error process is performed. Specifically, the port monitor PM (in more detail, the storage control part 36) inhibits the print data DT from being stored into the pull print storage area SR and deletes the print data DT. Thus, when the authentication information AT is not determined to be valid, the port monitor PM inhibits the print data DT from being stored into the pull print storage area SR.

On the other hand, when the authentication information AT is determined to be valid, the process goes to Step SP16.

In Step S16, the port monitor PM (in more detail, the storage control part 36) moves and stores the print data DT which is received in advance to/into the pull print storage area SR inside the pull print server 40 (see FIGS. 5, 7, and 14). Thus, the port monitor PM stores the print data DT into the pull print storage area SR on the condition that the authentication information AT is determined to be valid.

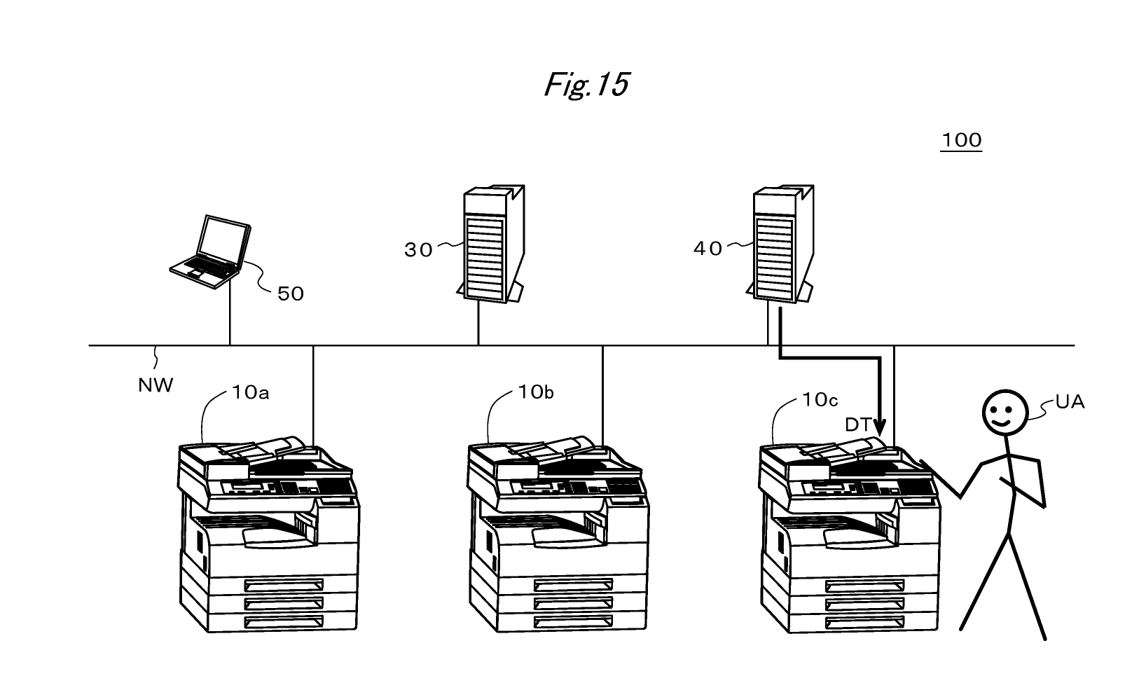

After that, in response to the operation of the user UA, one printing apparatus (e.g., the MFP 10c) among the printing target apparatus models acquires the print data DT stored in the pull print storage area SR and prints out the print data DT. In other words, an operation like a normal pull printing operation is performed. Specifically, the user UA operates an operation part of the printing target apparatus 10 (herein, the MFP 10c) to specify the print data DT and give a print instruction. In response to the print instruction, the MFP 10c pulls (acquires) the print data DT corresponding to the print instruction input from the pull print storage area SR of the pull print server 40 and performs the printing operation (see FIGS. 6 and 15).

In the above-discussed operation, the port monitor PM acquires the print data DT in which the encrypted authentication information AT is embedded, via the printer driver PD (Step SP12). Then, the port monitor PM requests the apparatus of the same model as the printing target apparatus model to perform the authentication operation on the encrypted authentication information AT (Steps SP13 and SP14). The encrypted authentication information AT is decrypted by the MFP 10b which is the same apparatus model as the printing target apparatus model and the authentication operation is performed by using the decrypted authentication information AT.

Thus, since the authentication operation is performed by using the authentication information AT unique to the pull printing system instead of the user information in the OS in the present system, it is possible to improve the security. Especially since the authentication information AT including not only the user ID but also the password information is used for the authentication operation, it is possible to ensure higher security than that in the case of using only the login user name for the OS.

Further, invalid print data DT (the print data having no valid authentication information) is rejected, not to be stored in the pull print storage area SR. Accordingly, it is possible to inhibit the invalid print data DT (the print data DT requested by uncertain person, or the like) from being stored into the pull print storage area SR. Therefore, it is possible to prevent the pull print storage area SR from being brought into a saturated state even if the third party intentionally transmits a large amount of print data DT. Further, since the print data DT not being stored in the pull print storage area SR is not printed out, it is also possible to prevent a user who does not know that the print data DT is invalid from printing out unnecessary printed matters.

### 2. The Second Preferred Embodiment

The first preferred embodiment has shown the technique for determining whether or not the print data DT should be stored into the pull print storage area SR of the pull print server 40 from the print server 30 on the basis of the authentication information AT which is acquired via the printer driver PD (and the print data DT).

The second preferred embodiment will show a technique for determining whether or not the print data DT stored in the pull print storage area SR of the pull print server 40 should be printed out by the MFP 10 on the basis of the authentication information AT which is acquired via the printer driver PD (and the print data DT). In the technique in accordance with the second preferred embodiment, especially, since invalid data out of the print data DT stored in the pull print storage area SR is rejected, not to be printed out, it is possible to prevent the print data DT requested by uncertain person from being printed out involuntarily by the user UA.

In the second preferred embodiment, no validity check on the print data DT is performed in the print server 30 and all the print data DT are stored into the pull print storage area SR of the pull print server 40 from the print server 30. Then, when a pull printing operation is performed by the user using the MFP 10c, the validity of the print data DT is checked.

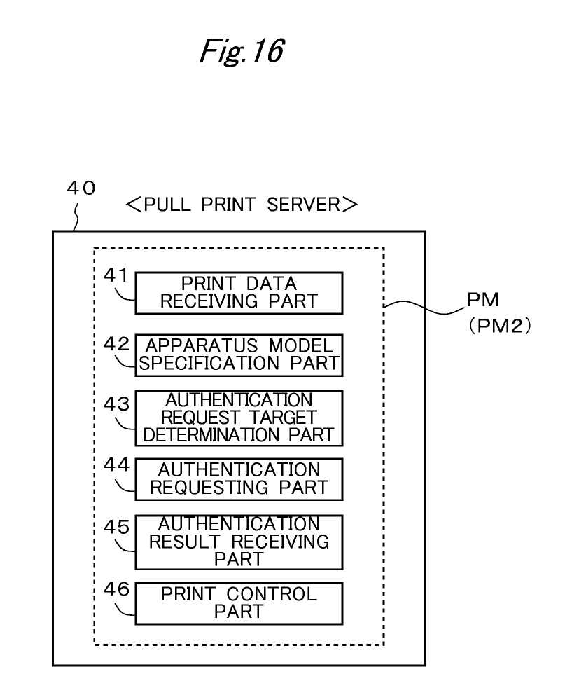

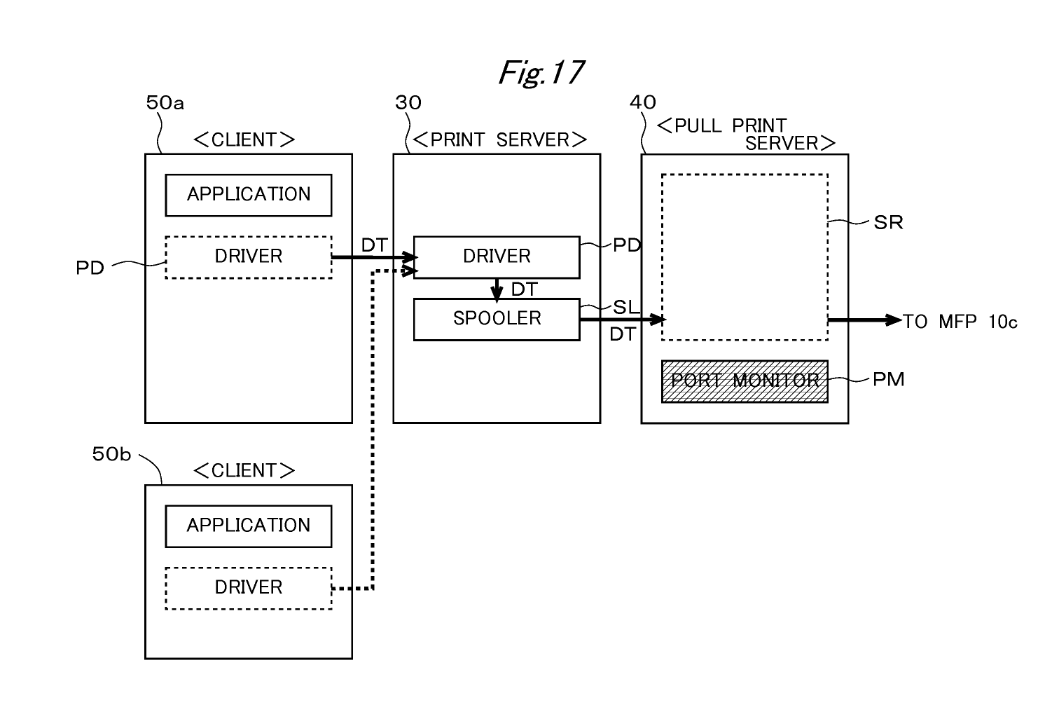

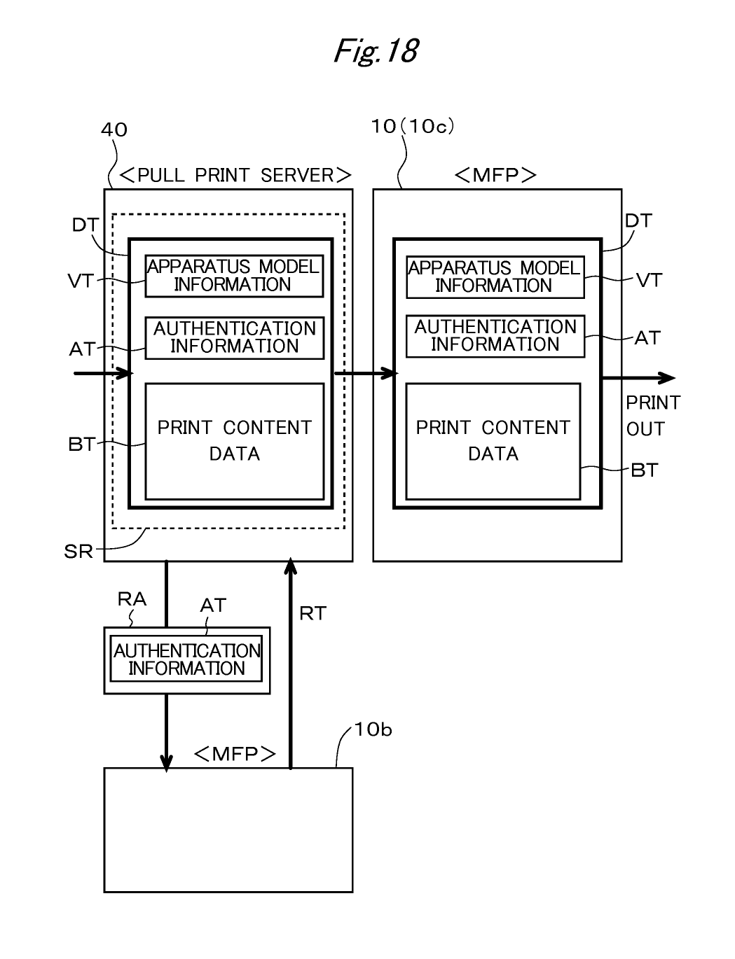

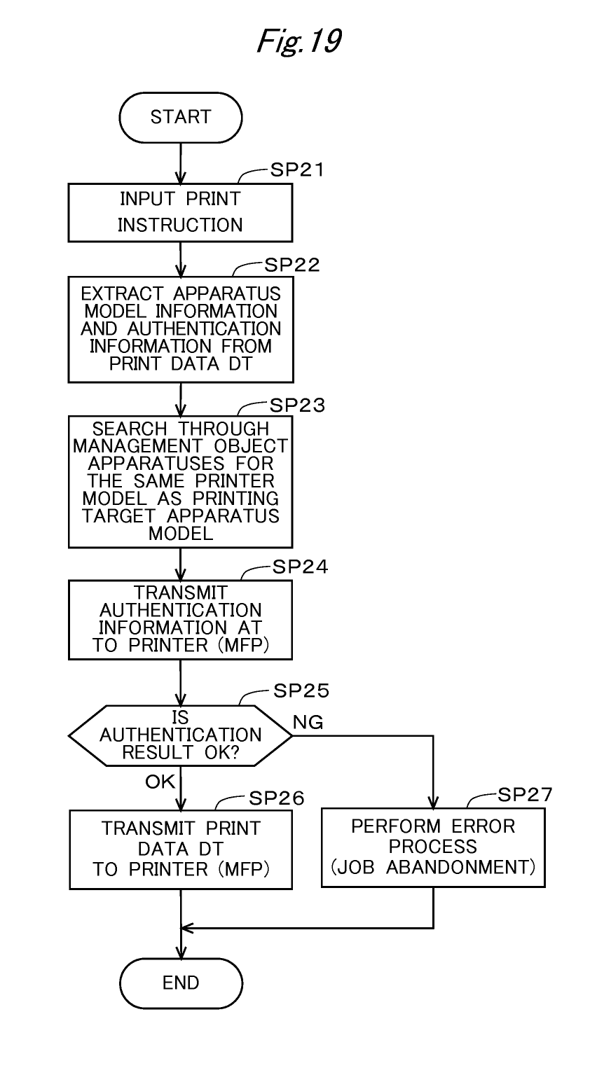

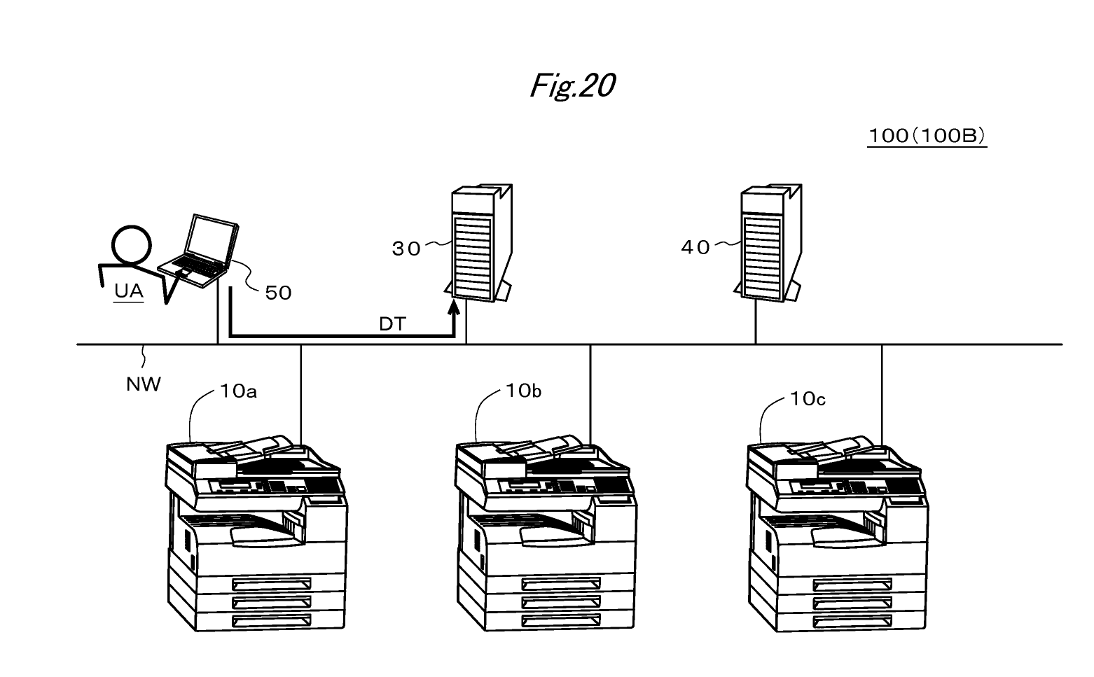

FIG. 16 is a functional block diagram showing a constitution of a pull print server 40 (40B) in accordance with the second preferred embodiment. FIG. 17 is a view showing locations of the printer driver PD and the port monitor PM, and the like, in a system 100B in accordance with the second preferred embodiment. FIG. 18 is a view showing an authentication operation performed in the system 100B in accordance with the second preferred embodiment. FIG. 19 is a flowchart showing an operation in accordance with the second preferred embodiment. FIGS. 20 to 25 are views sequentially showing the transmission of the data and the like in accordance with the second preferred embodiment.

As shown in FIGS. 16 and 17, in the system 100B of the second preferred embodiment, the port monitor PM (PM2) is installed in the pull print server 40, instead of the print server 30.

Further, as shown in FIG. 17, the port monitor PM2 has functions like those of the port monitor PM (PM1) of the first preferred embodiment. Specifically, the port monitor PM2 comprises a print data receiving part 41, an apparatus model specification part 42, an authentication request target determination part 43, an authentication requesting part 44, an authentication result receiving part 45, and a print control part 46.

The print data receiving part 41 is a processing part like the print data receiving part 31. The print data receiving part 41, however, acquires the print data DT in which the encrypted authentication information AT (pieces of information on the user ID, the password, and the like) is embedded via the pull print storage area SR. The print data receiving part 41 is also referred to as a print data acquisition part.

The apparatus model specification part 42, the authentication request target determination part 43, the authentication requesting part 44, and the authentication result receiving part 45 are the same processing parts as the apparatus model specification part 32, the authentication request target determination part 33, the authentication requesting part 34, and the authentication result receiving part 35, respectively.

The print control part 46 is a processing part for controlling whether or not the print data DT should be pulled from the pull print storage area SR, and the like. The print control part 46 permits the print data DT to be printed out on the condition that the authentication information AT is determined to be valid.

With reference to FIGS. 17 to 19 and the like, an operation of the second preferred embodiment will be discussed.

First, like in the first preferred embodiment, the user UA operates the client 50a and the above-discussed print data DT is thereby generated in the client 50 and transmitted to the print server 30 (see FIGS. 17 and 20 and the like). In more detail, the print data DT is temporarily stored into the spooler SL of the print server 30 (see especially FIG. 17).

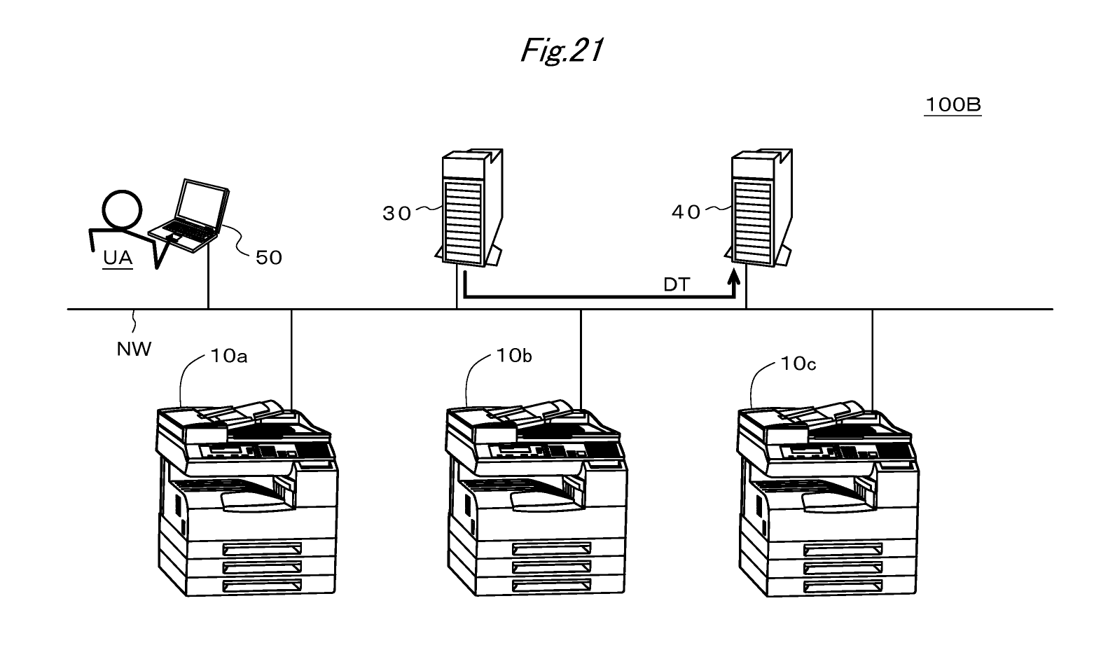

Next, the port monitor PM2 which monitors the spooler SL detects the print data DT in the spooler SL, the port monitor PM2 receives and acquires the print data DT. In other words, the port monitor PM2 (in more detail, the print data receiving part 41) receives the print data DT in which the encrypted authentication information AT is embedded from the client 50 (print requesting apparatus) and stores the print data DT into the pull print storage area SR of the pull print server 40 (see especially FIGS. 17 and 21).

Herein, the port monitor PM2 of the second preferred embodiment does not perform the validity check on the print data DT in the print server 30 and sequentially stores all the print data DT into the pull print storage area SR inside the pull print server 40 from the print server 30 (see FIG. 21).

After that, an operation shown in the flowchart of FIG. 19 is performed.

First, in Step SP21, the user UA moves to the location of the printing apparatus (herein, the MFP 10c) and an authentication operation on the user UA for the printing apparatus is performed. Specifically, the authentication operation is performed by checking the authentication information (inputted information) inputted by user UA using the operation panel 6c of the MFP 10c against the preset authentication information (certified information). As the authentication information, for example, the user ID and the password are used.

Then, a list screen GA3 (not shown) on the print data DT is displayed on the operation panel 6c of the MFP 10c on the condition that the authentication operation succeeds. After that, the user performs a printing operation by using the MFP 10c.

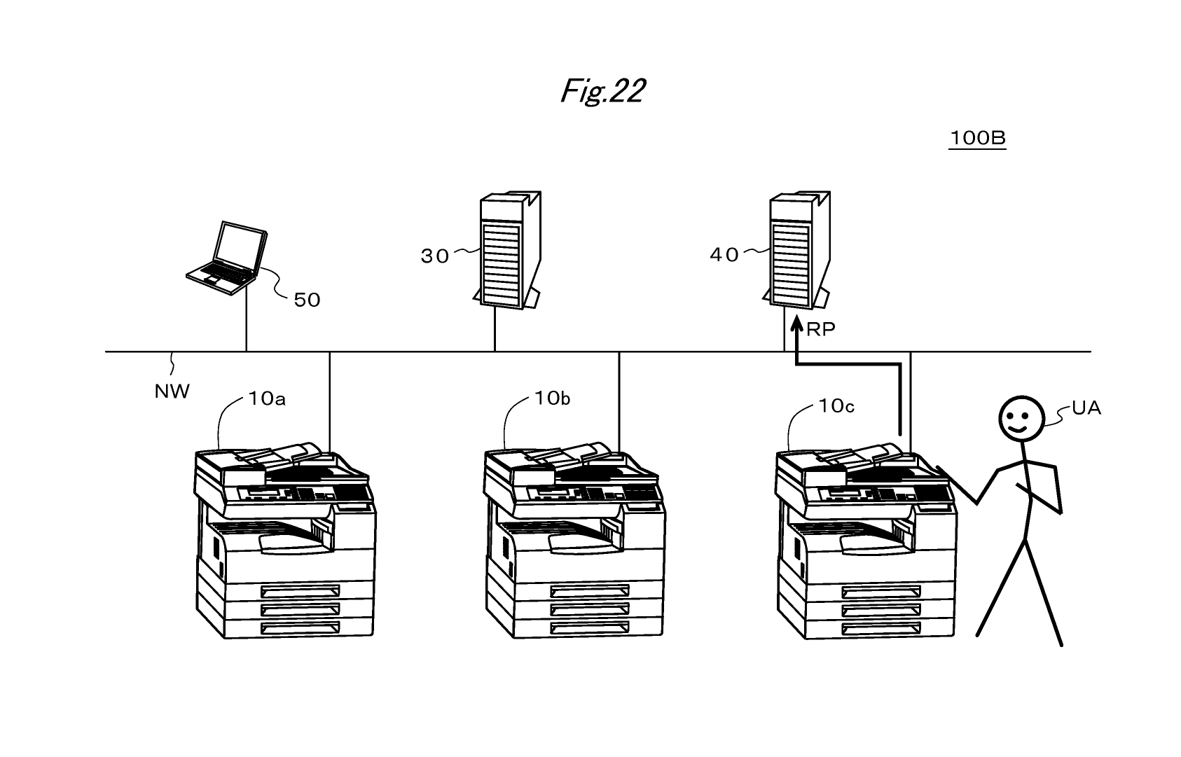

Specifically, the user UA operates the operation part of the apparatus 10 (herein, the MFP 10c) to specify desired print data DT out of a plurality of print data displayed in the list screen GA3 and give a print instruction input. In response to the print instruction input, the MFP 10c sends a print request RP to the pull print server 40 (see FIG. 22).

In the subsequent Step SP22, in response to the print request RP, the port monitor PM2 (in more detail, the print data receiving part 41) acquires the print data DT from the pull print storage area SR. Further, the port monitor PM2 (in more detail, the apparatus model specification part 42) extracts and acquires the apparatus model information VT from the print data DT, to thereby specify the printing target apparatus model. For example, when the apparatus model “ABCDE” is acquired as the apparatus model information VT, the port monitor PM2 specifies the apparatus model “ABCDE” as the printing target apparatus model. The port monitor PM2 further extracts and acquires the authentication information AT. At that time, the authentication information AT, being encrypted, is extracted and acquired.

In Step SP23, the port monitor PM2 (in more detail, the authentication request target determination part 43) searches through the plurality of MFPs 10 (printing apparatuses) for an apparatus of the same model as the printing target apparatus model and determines the apparatus of the same model (e.g., the MFP 10b) to be the authentication request target apparatus.

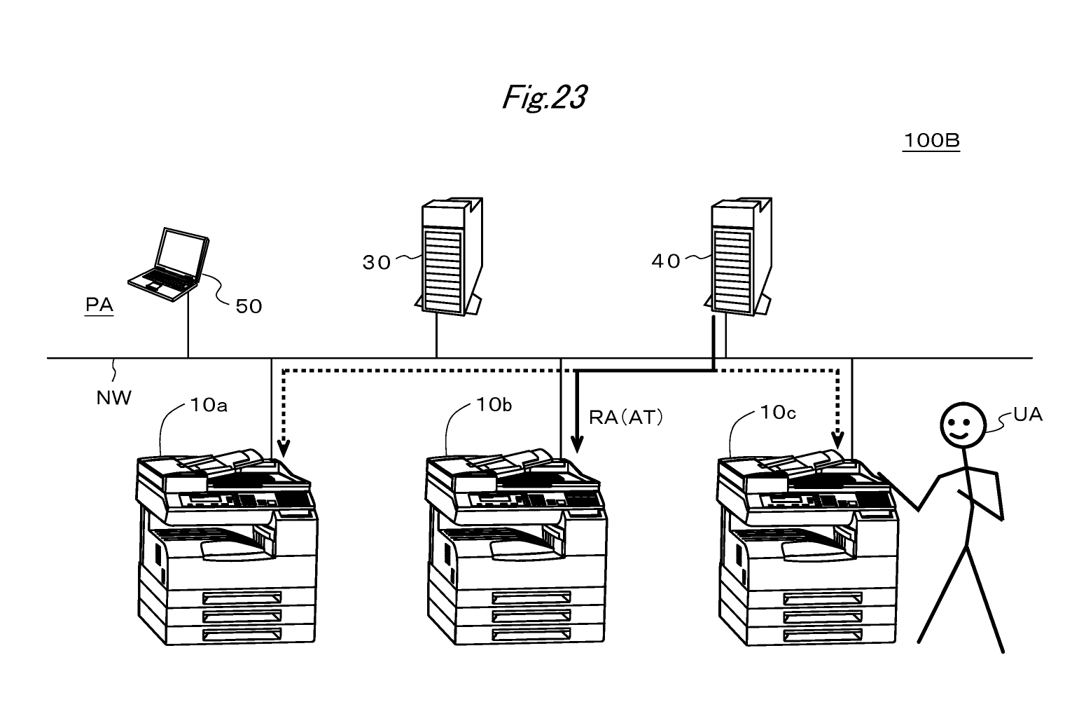

Next, in Step SP24, the port monitor PM2 (in more detail, the authentication requesting part 44) transmits the encrypted authentication information AT to the “authentication request target apparatus” and requests the “authentication request target apparatus” (e.g., the MFP 10b) to perform the authentication operation on the authentication information AT (see FIGS. 18 and 23). More specifically, the port monitor PM2 sends the authentication request instruction RA to the authentication request target apparatus 10b.

Thus, the port monitor PM2 extracts the encrypted authentication information AT from the print data and requests the same apparatus model (associated with the printer driver) which is capable of decrypting the authentication information AT to perform the authentication operation.

On the other hand, the “authentication request target apparatus” which receives the authentication request instruction RA (including the encrypted authentication information AT) uses the authentication part 12 (see FIG. 2) to perform the authentication operation. In other words, when the “authentication request target apparatus” (e.g., the MFP 10b) receives the “authentication request” from the “authentication requesting apparatus” (e.g., the print server 30) by using the authentication request receiving part 11, the “authentication request target apparatus” performs the authentication operation.

The authentication request target apparatus decrypts the encrypted authentication information AT embedded in the print data DT by using a decrypting key which the apparatus has and checks the decrypted authentication information AT against the certified authentication information (certified information) CT stored in the MFP 10b or the like.

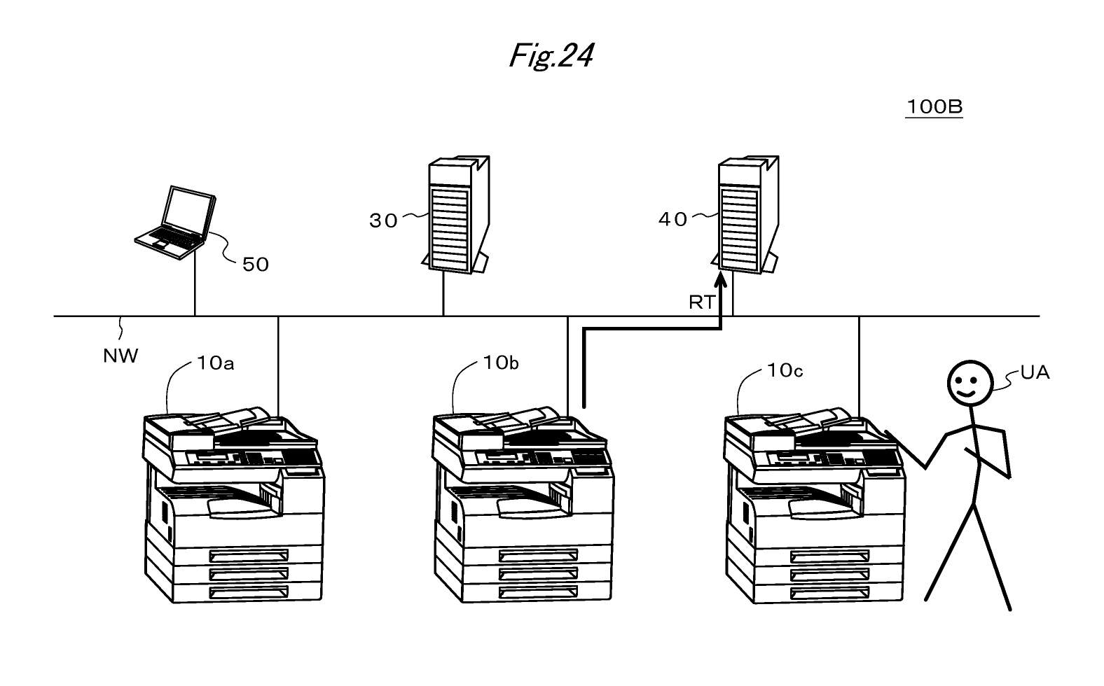

Then, as shown in FIG. 24, the check result (i.e., the authentication result) RT is transmitted (sent back) to the pull print server 40 by the authentication result transmitting part 13 (see FIG. 18).

When the port monitor PM2 in the pull print server 40 receives the authentication result RT by using the authentication result receiving part 45, the port monitor PM2 performs a branch operation in accordance with the authentication result RT (Step SP25).

When the authentication information AT is not determined to be valid, the process goes to Step SP27 where the error process is performed. Specifically, the port monitor PM2 (in more detail, the print control part 46) inhibits the print data DT from being printed out and deletes the print data DT from the pull print storage area SR. Thus, when the authentication information AT is not determined to be valid, the port monitor PM2 inhibits the print data DT from being printed out.

On the other hand, when the authentication information AT is determined to be valid, the process goes to Step SP26.

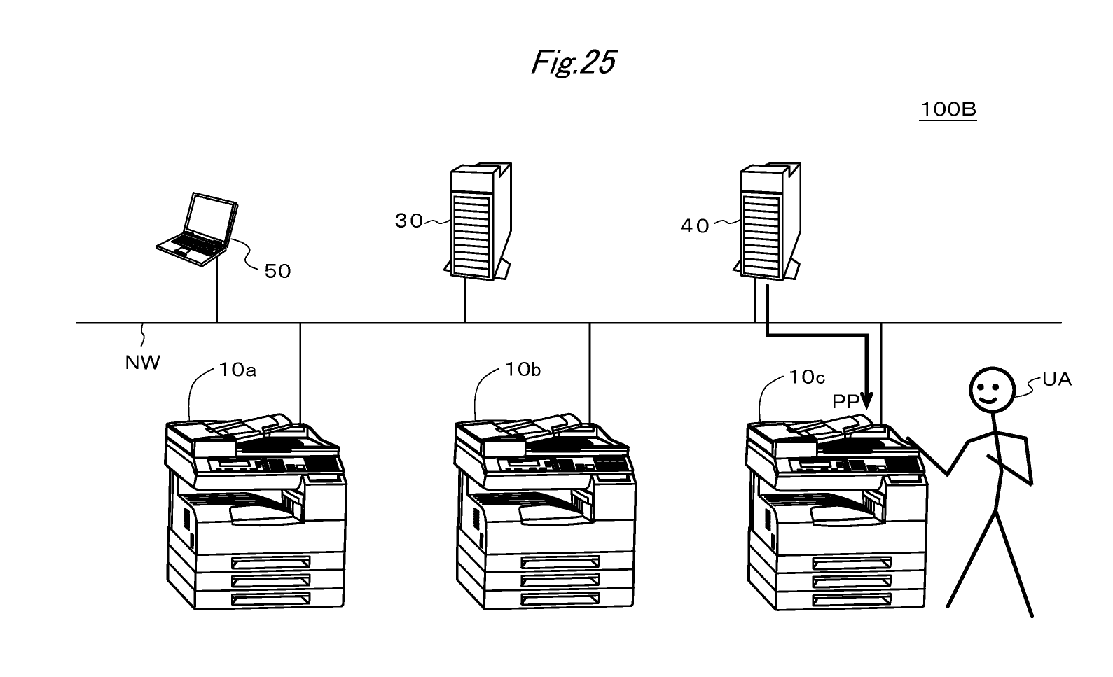

In Step S26, the port monitor PM2 (in more detail, the print control part 46) transmits print permission data PP to the MFP 10c and permits the printing apparatus (MFP 10c) to print out the print data DT (see FIG. 25). Thus, the port monitor PM2 permits printing of the print data DT on the condition that the authentication information AT is determined to be valid.

Then, the MFP 10c prints out a printed matter on the basis of the print data DT also on the condition that the authentication operation performed by the port monitor PM2 succeeds. Specifically, when the MFP 10c receives the print permission as the result of the authentication operation, the MFP 10c acquires the print data DT from the pull print storage area SR and performs the printing operation on the basis of the print data DT.

Herein, considered is a technique (also referred to as a technique in accordance with a second comparative example) in which printing of the print data DT is unconditionally permitted when the user UA who is authenticated as the result of the authentication operation in Step SP21 selects the print data DT for himself (user UA) which is stored in the pull print storage area SR and gives an instruction for pull printing.

In the technique of the second comparative example, however, even invalid print data DT may be also printed out.

In contrast to this technique, in the operation of the second preferred embodiment, when the user UA uses the MFP 10c to perform the pull printing operation, the validity of the print data DT is checked, to thereby determine whether the print data DT should be printed out or not.

Specifically, the port monitor PM2 acquires the print data DT in which the encrypted authentication information AT is embedded, via the printer driver PD, and requests an apparatus which is the same model as the printing target apparatus model to perform the authentication operation on the basis of the authentication information AT (Steps SP21 to SP24). Further, the encrypted authentication information AT is decrypted by the same apparatus model as the printing target apparatus model and the authentication operation is performed by using the decrypted authentication information AT. Then, on the condition that the authentication information is determined to be valid in the authentication operation, the printing apparatus 10c is permitted to print out the print data (Steps SP25 and SP26) and acquires the print data DT stored in the pull print storage area SR, to print out the print data DT. On the other hand, invalid print data DT is inhibited from being printed out (Steps SP25 and SP27).

Therefore, since the printing operation is not permitted for the print data having no valid authentication information (the print data DT requested by uncertain person, or the like), it is possible to prevent the invalid print data from being printed out. In other words, it is possible to prevent unnecessary printed matters from being generated. Especially, even when the third party intentionally transmits unnecessary print data DT (a large amount of data or the like), it is possible to prevent a user who does not know that the print data DT is invalid from printing out unnecessary printed matters corresponding to the print data DT. Thus, it is possible to further improve the security in the pull printing system.

### 3. Variations

Though the preferred embodiments of the present invention have been discussed above, the present invention is not limited to the above-discussed preferred embodiments, but allows various variations.

For example, in the above-discussed preferred embodiments, the case has been shown where the two server functions are provided separately in the two different server apparatuses (also referred to simply as “servers”) 30 and 40. Specifically, the pull print server function is implemented in the pull print server 40 and the print server function is implemented in the print server 30. This is, however, only one exemplary case. The two server functions (the print server function and the pull print server function) may be implemented in a single server apparatus (also referred to simply as a “server”). The “server (apparatus)” which implements both the two server functions may be referred to both as a “print server” and as a “pull print server”.

Though the pull print storage area SR is provided in the pull print server 40 separately from the print server 30 in the above-discussed preferred embodiments, this is only one exemplary case. For example, the pull print storage area SR may be provided in a single server which has both the functions of the print server 30 and the pull print server 40.

Further, though the case has been discussed where the MFP 10b and the MFP 10c are the same apparatus model and the MFP 10b serves as an authentication request target apparatus and the MFP 10c serves as a printing apparatus in the above-discussed preferred embodiments, this is only one exemplary case. For example, the MFP 10c (or the MFP 10b or the like) may serve both as the authentication request target apparatus and as the printing apparatus.

Though the case has been discussed where the authentication information AT is stored in the single print data DT in the above-discussed preferred embodiments, this is only one exemplary case. For example, the authentication information AT may be stored in print data (also referred to as “print job data” or the like) consisting of a plurality of data groups (partial data). In more detail, there may be a case where the apparatus model information VT and the authentication information AT are stored in first partial data among the plurality of partial data and the print content data (original data body to be printed out) BT is stored in second partial data among the plurality of data groups.

While the invention has been shown and described in detail, the foregoing description is in all aspects illustrative and not restrictive. It is therefore understood that numerous modifications and variations can be devised without departing from the scope of the invention.

What is claimed is:

1. A pull printing system, comprising:
a plurality of clients;
a server; and
a plurality of printing apparatuses,
wherein said server comprises:
a print data receiving part for receiving print data from a print requesting apparatus among said plurality of clients, said print data being generated in response to a user's first operation, in which authentication information which is encrypted, being decryptable by a printing target apparatus model among said plurality of printing apparatuses, is embedded;
an apparatus model specification part for extracting information on said printing target apparatus model from said print data to specify said printing target apparatus model;
an authentication request target determination part for searching through said plurality of printing apparatuses for an apparatus of the same model as said printing target apparatus model and determining said apparatus of the same model to be an authentication request target apparatus;
an authentication requesting part for transmitting said authentication information, being encrypted, to said authentication request target apparatus capable of decrypting said authentication information and requesting said authentication request target apparatus to perform an authentication operation including an operation of decrypting said authentication information;
an authentication result receiving part for receiving an authentication result obtained by said authentication operation; and
a storage control part for storing said print data into a pull print storage area on the condition that said authentication information is determined to be valid on the basis of said authentication result,
and wherein one of said plurality of printing apparatuses which is said printing target apparatus model acquires said print data stored in said pull print storage area and prints out said print data in response to a user's second operation.

2. A pull printing system in which a printing apparatus acquires print data stored in a pull print storage area and prints out said print data in response to an operation of a print requesting apparatus relating to printing, comprising:
a print data receiving part for receiving print data in which authentication information which is encrypted, being decryptable by a printing target apparatus model, is embedded, from a print requesting apparatus;
an apparatus model specification part for extracting information on said printing target apparatus model from said print data to specify said printing target apparatus model;
an authentication request target determination part for searching for an apparatus of the same model as said printing target apparatus model and determining said apparatus of the same model to be an authentication request target apparatus;
an authentication requesting part for transmitting said authentication information, being encrypted, to said authentication request target apparatus capable of decrypting said authentication information and requesting said authentication request target apparatus to perform an authentication operation including an operation of decrypting said authentication information;
an authentication result receiving part for receiving an authentication result obtained by said authentication operation; and
a storage control part for storing said print data into a pull print storage area on the condition that said authentication information is determined to be valid on the basis of said authentication result.

3. The pull printing system according to claim 2, wherein
said authentication information is embedded in said print data by a printer driver on the basis of information inputted from said print requesting apparatus by a user.

4. The pull printing system according to claim 2, wherein
said authentication information includes password information.

5. A non-transitory computer-readable recording medium for recording therein a computer program to be executed by a computer to cause said computer to perform the steps of:
a) receiving print data in which authentication information which is encrypted, being decryptable by a printing target apparatus model, is embedded, from a print requesting apparatus;
b) extracting information on said printing target apparatus model from said print data to specify said printing target apparatus model;
c) searching for an apparatus of the same model as said printing target apparatus model and determining said apparatus of the same model to be an authentication request target apparatus;
d) transmitting said authentication information, being encrypted, to said authentication request target apparatus capable of decrypting said authentication information and requesting said authentication request target apparatus to perform an authentication operation including an operation of decrypting said authentication information;
e) receiving an authentication result obtained by said authentication operation; and
f) storing said print data into a pull print storage area on the condition that said authentication information is determined to be valid on the basis of said authentication result.

6. The recording medium according to claim 5, wherein
said authentication information is embedded in said print data by a printer driver on the basis of information inputted from said print requesting apparatus by a user.

7. The recording medium according to claim 5, wherein
said authentication information includes password information.

8. A pull printing system, comprising:
a plurality of clients;
a server; and
a plurality of printing apparatuses,
wherein said server comprises:
a print data acquisition part for acquiring print data generated and stored into a pull print storage area in response to a user's first operation from said pull print storage area in response to a user's second operation, said print data having authentication information which is encrypted and embedded therein, said authentication information being decryptable by a printing target apparatus model among said plurality of printing apparatuses;
an apparatus model specification part for extracting information on said printing target apparatus model from said print data to specify said printing target apparatus model;
an authentication request target determination part for searching through said plurality of printing apparatuses for an apparatus of the same model as said printing target apparatus model and determining said apparatus of the same model to be an authentication request target apparatus;
an authentication requesting part for transmitting said authentication information, being encrypted, to said authentication request target apparatus capable of decrypting said authentication information and requesting said authentication request target apparatus to perform an authentication operation including an operation of decrypting said authentication information;
an authentication result receiving part for receiving an authentication result obtained by said authentication operation; and
a print control part for permitting one of said plurality of printing apparatuses which is said printing target apparatus model to print out said print data on the condition that said authentication information is determined to be valid on the basis of said authentication result,
and wherein said one printing apparatus acquires said print data stored in said pull print storage area and prints out said print data.

9. A pull printing system in which a printing apparatus acquires print data stored in a pull print storage area and prints out said print data in response to an operation of a print requesting apparatus relating to printing, comprising:
a print data acquisition part for acquiring print data in which authentication information which is encrypted, being decryptable by a printing target apparatus model, is embedded, from said pull print storage area;
an apparatus model specification part for extracting information on said printing target apparatus model from said print data to specify said printing target apparatus model;
an authentication request target determination part for searching for an apparatus of the same model as said printing target apparatus model and determining said apparatus of the same model to be an authentication request target apparatus;
an authentication requesting part for transmitting said authentication information, being encrypted, to said authentication request target apparatus capable of decrypting said authentication information and requesting said authentication request target apparatus to perform an authentication operation including an operation of decrypting said authentication information;
an authentication result receiving part for receiving an authentication result obtained by said authentication operation; and
a print control part for permitting printing of said print data on the condition that said authentication information is determined to be valid on the basis of said authentication result.

10. The pull printing system according to claim 9, wherein
said authentication requesting part requests said authentication request target apparatus to perform said authentication operation when a user operates said printing apparatus to perform printing, and
said print control part permits said printing apparatus to print out said print data on the condition that said authentication information is determined to be valid.

11. The pull printing system according to claim 9, wherein
said authentication information is embedded in said print data on the basis of information inputted from said print requesting apparatus by a user.

12. The pull printing system according to claim 9, wherein
said authentication information includes password information.

13. A non-transitory computer-readable recording medium for recording therein a computer program to be executed by a computer to cause said computer to perform the steps of:
a) acquiring print data in which authentication information which is encrypted, being decryptable by a printing target apparatus model, is embedded, from a pull print storage area;
b) extracting information on said printing target apparatus model from said print data to specify said printing target apparatus model;
c) searching for an apparatus of the same model as said printing target apparatus model and determining said apparatus of the same model to be an authentication request target apparatus;
d) transmitting said authentication information, being encrypted, to said authentication request target apparatus capable of decrypting said authentication information and requesting said authentication request target apparatus to perform an authentication operation including an operation of decrypting said authentication information;
e) receiving an authentication result obtained by said authentication operation; and
f) permitting printing of said print data on the condition that said authentication information is determined to be valid on the basis of said authentication result.

14. The recording medium according to claim 13, wherein
said step d) has a step of requesting said authentication request target apparatus to perform said authentication operation when a user operates said printing apparatus to perform printing, and
said step f) has a step of permitting said printing apparatus to print out said print data on the condition that said authentication information is determined to be valid.

15. The recording medium according to claim 13, wherein
said authentication information is embedded in said print data on the basis of information inputted from said print requesting apparatus by a user.

16. The recording medium according to claim 13, wherein
said authentication information includes password information.
